(19) United States
(12) Patent Application Publication
(10) Pub. No.: US 2010/0002864 A1
(43) Pub. Date: Jan. 7, 2010

(54) Method and System for Discerning Learning Characteristics of Individual Knowledge Worker and Associated Team In Service Delivery

(75) Inventors: Abhijit Bose, Paramus, NJ (US); Hung-Yang Chang, Scarsdale, NY (US); Sreeram Ramakrishnan, Yorktown Heights, NY (US); Debanjan Saha, Mohegan Lake, NY (US)

Correspondence Address: CAHN & SAMUELS, LLP, 1100 17th STREET, NW, SUITE 401, WASHINGTON, DC, 20036, US

(73) Assignee: INTERNATIONAL BUSINESS MACHINES CORPORATION, Armonk, NY (US)

(21) Appl. No.: 12/167,196

(22) Filed: Jul. 2, 2008

(51) Int. Cl. H04M 3/00

(52) U.S. Cl. 379/265.06

(57) ABSTRACT

A method and system for measuring the learning ability and productivity of knowledge workers related to the delivery of services in service industry sectors, such as information technology (IT), healthcare and accounting. The method and system applies broadly to service domains that have a strong correlation between the learning ability and skill level of workers wherein the correlation affects the quality of service delivery. Utilizing data mining techniques, the method and system captures, analyzes and benchmarks individual knowledge worker's skill(s) in order to normalize individual service agent proficiencies. The normalized service agent proficiencies allows the relative learning and skill indices of the individual service agents to be determined such that the skills and learning abilities of individual service agents to be determined. The method and system allows best practices and training thresholds to be determined.

### I. FIELD OF THE INVENTION

The present invention relates to a method and system for measuring the learning ability and productivity of knowledge workers. The invention is particularly related to knowledge workers and the delivery of services in service industry sectors, such as information technology (IT), healthcare and accounting. However, the invention applies broadly to any service domain having a strong correlation between the learning ability and skill level of workers wherein the correlation affects the quality of service delivery.

### II. BACKGROUND OF THE INVENTION

Service industries are typically very labor intensive sectors of the workforce. The quality of service delivery has been found to be highly sensitive to variances in the individual skill and knowledge levels of personnel in these sectors. As an example, the resolution time for a typical type of IT service, e.g., a database recovery service, may vary significantly amongst various individual service agents. These variances are most often due to disparities in the knowledge and skill levels of the individual agents. As such, it would be beneficial to identify and measure any gaps in the skills and learning abilities of delivery workers.

In order to identify and measure these gaps it is necessary to capture, analyze and benchmark these skills—individually and with respect to associated individuals and teams. The available prior art focuses on capturing agent performance, e.g., call center agent's performance, but fails to carry out analysis and benchmarking of individual skill(s) with respect to a team.

### III. SUMMARY OF THE INVENTION

In at least one embodiment, the present invention provides a method, including capturing the activities of service agents; analyzing the captured activities; normalizing the captured activities; and computing the relative learning and skill indices of the service agents.

In at least another embodiment, the present invention provides a system, including an activity capture agent; a database in communication with the activity capture agent; a data miner in communication with the database; and a learning agent in communication with the data miner.

In at least one embodiment, the present invention provides a system, including means for capturing the activities of service agents; means for analyzing the captured activities; means for normalizing the captured activities; and means for computing the relative learning and skill indices of the service agents.

In at least one embodiment, the present invention provides a computer program product comprising a computer useable medium including a computer readable program, wherein the computer readable program when executed on a computer causes the computer to capture the activities of individual service agents; analyze the captured activities; normalize the captured activities; and compute the relative learning and skill indices of the service agents.

Given the following enabling description of the drawings, the apparatus should become evident to a person of ordinary skill in the art.

### IV. BRIEF DESCRIPTION OF THE DRAWINGS

The present invention is described with reference to the accompanying drawings, wherein:

FIG. 1 illustrates an overview of the system in accordance with an exemplary embodiment of the present invention.

FIG. 2 illustrates an overview of the method in accordance with an exemplary embodiment of the present invention.

FIG. 3 illustrates a more detailed method in accordance with an exemplary embodiment of the present invention.

### V. DETAILED DESCRIPTION OF THE DRAWINGS

The present invention discloses a method and system that identifies and measures the learning ability and productivity of service industry knowledge workers by capturing, analyzing and benchmarking individual knowledge worker's skill(s). While the invention is referred to and described herein with respect to knowledge workers and the delivery of services in service industry sectors, such as information technology (IT), healthcare, and accounting, the invention is not intended to be limited to those areas. The invention can also be used in any service domain having a strong correlation between the learning ability and skill level of workers wherein the correlation affects the quality of service delivery.

The present invention utilizes a system for capturing the variations in skills and learning ability of service agents or workers by analyzing historical data from the service processes. This process is performed in two stages. In the first stage, the individual activities performed by service agents are captured. Data mining techniques are utilized to extract the activities of interest of the captured activities. Performance indicators or metrics are then applied to these captured activities to highlight variations in the ability of individual service agents to resolve problems of similar categories and/or levels of difficulty. In the second stage, the performance indicators or metrics are normalized against all participants of the process. Performing these steps allows the relative learning and skill indices to be computed for each service worker. The relative learning and skill indices enables the identification of workers who may require training and additional learning in order to attain certain levels of competency, e.g., minimum or average proficiency. This system thereby avoids the use of ad hoc measures of worker skill levels by providing a rigorous measurement and analysis solution for service worker proficiency.

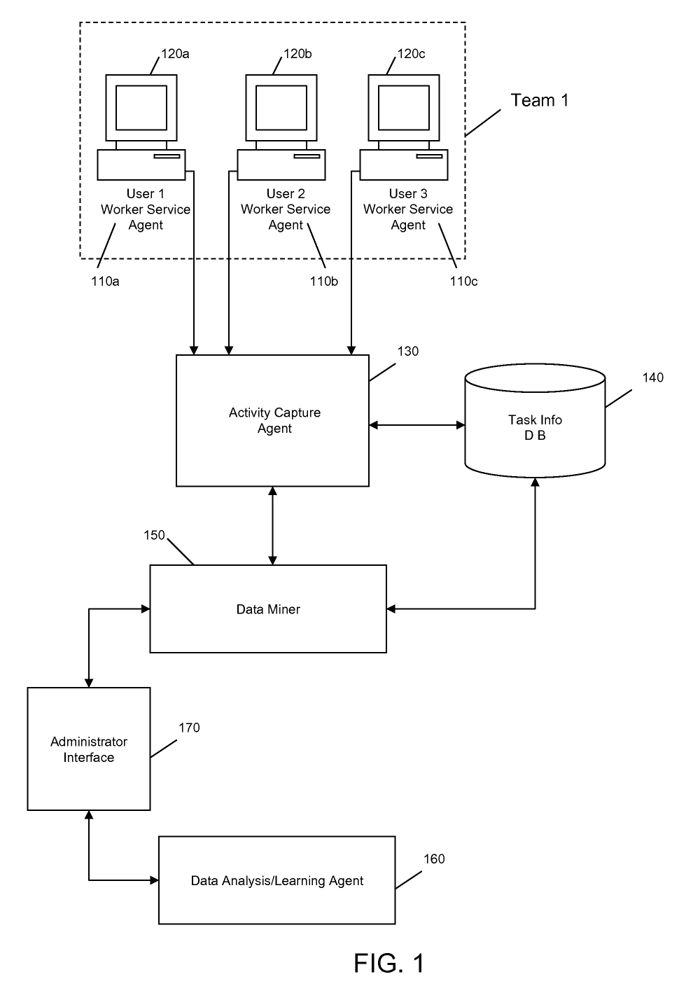

FIG. 1 illustrates an example of an embodiment of the system of the present invention. The exemplary system captures the activities performed by various individual workers or service agents 110a, 110b, 110c. The activities may be performed on devices, e.g., computers 120a, 120b, 120c, which may be grouped into teams, e.g., Teams 1 through Team X. The activities are captured by an activity capture agent 130 and stored to a task information database 140. A data miner 150 is in communication with the task information database 140 and the activity capture agent 130. A data analysis/learning agent 160 is in communication with the data miner 150 via an administrator interface 170.

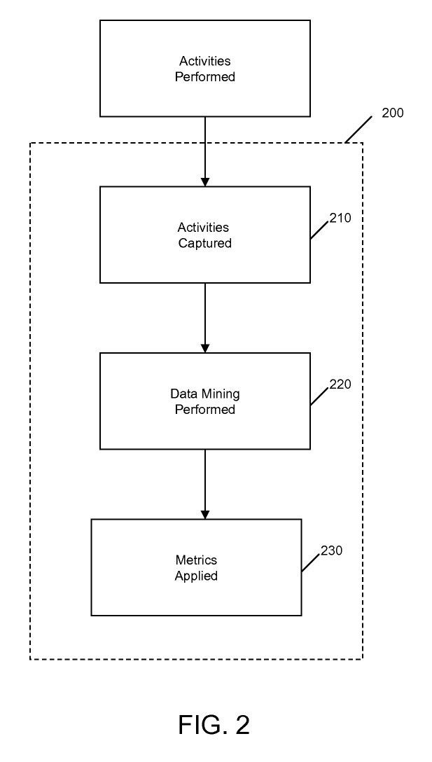

FIG. 2 illustrates an exemplary overview of the method of the present invention. The method 200 includes three general steps. At 210, activities performed by individual service agents to deliver requested services are captured. At 220, data mining of the captured activities is performed. At 230, metrics are applied to the mined data in order to compute the relative performance of each agent.

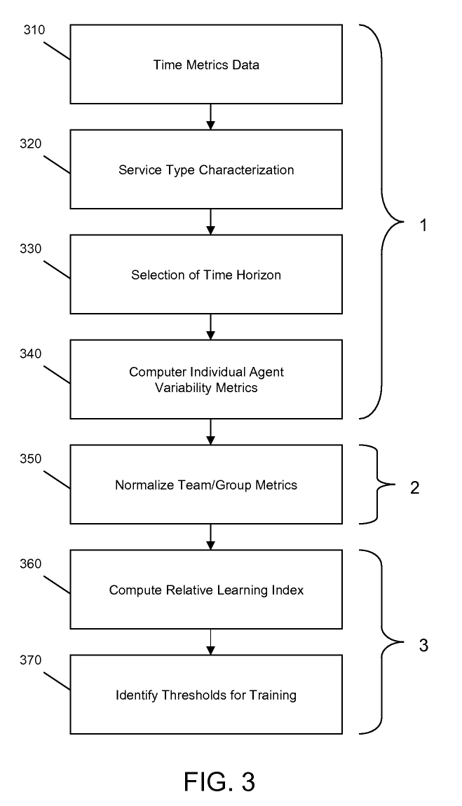

FIG. 3 outlines a more detailed methodology of the present invention having some steps organized into groups. The first group of steps (indicated by 1) involves segmenting the services performed by the agents, e.g., based on time, task difficulty and/or task priority level. The variation in these service metrics may be captured, for example, using standard statistical procedures such as computing mean and standard deviations. The second step comprises normalizing the service times across all agents of a given team. In the third step a relative performance index is computed for each agent in the system. The relative performance index identifies agents that may require additional training based on their performance as compared to other agents and/or against stated goals. The relative performance index also identifies agents that are top performers in the group. Also, because the methodology uses task difficulty level when segmenting the service times the tasks performed by the top performers may identify new best practices for the group.

The exemplary method outlined in FIG. 3 begins, at 310, with segmenting the time metrics data for the captured activities. At 320, the type of service associated with the captured activities is characterized, i.e., task difficulty, priority level, etc. At 330, a time horizon is selected over which the performance indices will be calculated. Choice of time horizon is important since performance can vary over time due to a number of reasons including worker retraining, increasing gap between work requirements and skills, etc. At 340, variability metrics are computed for individual agents based on the segmented metrics of the captured activities. At 350, variability metrics for the individual agents are normalized based on the metrics for an associated team or group. At 360, a relative learning index is computed for the individual agents. At 370, thresholds in the skills and learning abilities of the individuals are identified based on the computed metrics. These thresholds help to more reliably verify agent performance, such that high-performing and under-performing agents and best practices may be identified. Underperforming agents may also be retrained in order to become more efficient.

For a given set of tasks, activities by individual worker agents over a “reasonable” time interval are collected. For each activity time of interest the system analyzes and decomposes the collected activity data for individual worker agents over the entire time of interest. In addition, a peer group or team associated with particular individual worker agents is identified. This group may be defined as agents working on identical or related tasks, as appropriate. The system allows for the identification of particular time intervals during which the variability needs to be measured. For each of these time “epochs” the individual agent's activity time variability (for the same or related tasks) and the group's or team's time variability are computed. The ratio of the two variability metrics, controlled for other significant factors, defines the relative learning metric for individual worker agents. The significant factors considered may include, for example, project type, service type, duration, and prior experience with similar projects.

The relative learning index constitutes the relative value of an individual learning index (i.e., benchmarked against the team average). The learning index can be defined by a number of metrics, such as team, individual and/or work category. For example, the learning index for Team by Work Category is a measure of how a team is learning a particular category of service processes. The learning effect is measured using a simplified proxy of observed variability for particular process tasks and/or categories over time. This provides an indication of how a particular team's performance with respect to particular tasks has developed, i.e., maturing, stabilizing, regressing, etc., over time. A non-increasing trend can be associated with improved predictability. Whereas an erratic trend might represent an opportunity for re-training, additional training, or re-assignment. This index can be calculated on a variety of time intervals, including daily, weekly, monthly, quarterly, etc., as needed.

Another index example, the relative learning index for individuals by work category, is a metric of the ratio of the variability associated with an individual's performance with respect to particular services and whether that performance has changed with respect to the observed variability for the team working on the same service type. This metric provides an indication of whether a particular person-task combination is developing, i.e., increasing (maturing), stabilizing, decreasing (regressing), etc., over time with respect to the team.

Trends associated with this metric—whether increasing or decreasing—provide an indication of a worker's ability to “learn” the processes over time. A decreasing trend represents a tighter variability and improving overall service process predictability. An increasing trend represents an opportunity for re-training or additional training or even task re-assignments. This index can also be calculated on a variety of time intervals, including daily, weekly, monthly, quarterly, etc., as needed.

The invention can take the form of an entirely hardware embodiment, an entirely software embodiment or an embodiment containing both hardware and software elements. In at least one exemplary embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As will be appreciated by one of ordinary skill in the art, the present invention may be embodied as a computer implemented method, a programmed computer, a data processing system, a signal, and/or computer program. Accordingly, the present invention may take the form of an entirely hardware embodiment, an entirely software embodiment or an embodiment combining software and hardware aspects. Furthermore, the present invention may take the form of a computer program on a computer-usable storage medium having computer-usable program code embodied in the medium. Any suitable computer readable medium may be utilized including hard disks, CD-ROMs, optical storage devices, carrier signals/waves, or other storage devices.

Computer program code for carrying out operations of the present invention may be written in a variety of computer programming languages. The program code may be executed entirely on at least one computing device, as a stand-alone software package, or it may be executed partly on one computing device and partly on a remote computer. In the latter scenario, the remote computer may be connected directly to the one computing device via a LAN or a WAN (for example, Intranet), or the connection may be made indirectly through an external computer (for example, through the Internet, a secure network, a sneaker net, or some combination of these).

It will be understood that each block of the flowchart illustrations and block diagrams and combinations of those blocks can be implemented by computer program instructions and/or means. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the flowcharts or block diagrams.

The exemplary and alternative embodiments described above may be combined in a variety of ways with each other. Furthermore, the steps and number of the various steps illustrated in the figures may be adjusted from that shown.

It should be noted that the present invention may, however, be embodied in many different forms and should not be construed as limited to the embodiments set forth herein; rather, the embodiments set forth herein are provided so that the disclosure will be thorough and complete, and will fully convey the scope of the invention to those skilled in the art. The accompanying drawings illustrate exemplary embodiments of the invention.

Although the present invention has been described in terms of particular exemplary and alternative embodiments, it is not limited to those embodiments. Alternative embodiments, examples, and modifications which would still be encompassed by the invention may be made by those skilled in the art, particularly in light of the foregoing teachings.

Those skilled in the art will appreciate that various adaptations and modifications of the exemplary and alternative embodiments described above can be configured without departing from the scope and spirit of the invention. Therefore, it is to be understood that, within the scope of the appended claims, the invention may be practiced other than as specifically described herein.

We claim:

1. A method, comprising:
capturing the activities of service agents;
analyzing said captured activities;
normalizing said captured activities; and
computing the relative learning and skill indices of said service agents.

2. The method according to claim 1, further comprising:
utilizing said relative learning and skill indices to evaluate the skills and learning abilities of said service agents.

3. The method according to claim 1, wherein analyzing said captured activities includes:
utilizing time metrics data associated with said captured activities.

4. The method according to claim 1, wherein analyzing said captured activities includes:
segmenting said activities based on service type;
selecting a time horizon; and
computing individual service agent proficiencies.

5. The method according to claim 4, wherein normalizing said captured activities includes:
normalizing said individual service agent proficiencies based on an associated team of service agents.

6. The method according to claim 5, further comprising:
utilizing said individual service agent proficiencies to identify best practices.

7. The method according to claim 5, further comprising:
utilizing said individual service agent proficiencies to identify thresholds for training.

8. The method according to claim 1, wherein said activities are captured by an activity capture agent and stored in a database.

9. A system, comprising:
an activity capture agent;
a database in communication with said activity capture agent;
a data miner in communication with said database; and
a learning agent in communication with said data miner.

10. The system according to claim 9, further comprising:
an administrator interface in communication with said data miner and said learning agent.

11. The system according to claim 9, wherein said activity capture agent captures activities performed by at least one service agent.

12. The system according to claim 11, wherein said database stores said captured activities.

13. The system according to claim 11, wherein said data miner extracts said captured activities based on user interest.

14. The system according to claim 11, wherein said learning agent normalizes said captured activities across multiple of said at least one service agent.

15. A system, comprising:
means for capturing the activities of service agents;
means for analyzing said captured activities;
means for normalizing said captured activities; and
means for computing the relative learning and skill indices of said service agents.

16. The system according to claim 15, further comprising:
means for utilizing said relative learning and skill indices to evaluate the skills and learning abilities of said service agents.

17. The system according to claim 16, wherein said means for analyzing said captured activities includes:
means for utilizing time metrics data associated with said captured activities.

18. The system according to claim 16, wherein said means for analyzing said captured activities includes:
means for segmenting said activities based on service type;
means for selecting a time horizon; and
means for computing individual service agent proficiencies.

19. The system according to claim 18, wherein said means for normalizing said captured activities further includes:
means for normalizing said individual service agent proficiencies based on a service team.

20. The system according to claim 19, further comprising:
means for utilizing said individual service agent proficiencies to identify best practices.

21. The system according to claim 19, further comprising:
means for utilizing said individual service agent proficiencies to identify training thresholds.

22. A computer program product comprising a computer useable medium including a computer readable program, wherein the computer readable program when executed on a computer causes the computer to:
capture the activities of individual service agents;
analyze said captured activities;
normalize said captured activities; and
compute the relative learning and skill indices of said service agents.

23. A computer program product according to claim 22, wherein the computer readable program further causes the computer to:
evaluate the skills and learning abilities of said individual service agents based on said relative learning and skill indices.

24. A computer program product according to claim 22, wherein the computer readable program further causes the computer to:
utilize time metrics data associated with said captured activities;
segment said activities based on service type;
select a time horizon; and
compute individual service agent proficiencies.

25. A computer program product according to claim 24, wherein the computer readable program further causes the computer to:
normalize said individual service agent proficiencies based on an associated team of said individual service agents.
